(19) United States
(12) Patent Application Publication
(10) Pub. No.: US 2016/0298017 A1
(43) Pub. Date: Oct. 13, 2016

(54) TEMPORARY PLUGGING AGENT FOR WELL DRILLING

(71) Applicant: KUREHA CORPORATION, Tokyo (JP)

(72) Inventors: TAKEO TAKAHASHI, Tokyo (JP); MASAYUKI OKURA, Tokyo (JP); SHINYA TAKAHASHI, Tokyo (JP); TAKUMA KOBAYASHI, Tokyo (JP); FUMINORI KOBAYASHI, Tokyo (JP); HIROYUKI SATO, Tokyo (JP)

(21) Appl. No.: 15/036,149

(22) PCT Filed: Oct. 27, 2014
(86) PCT No.: PCT/JP2014/078518

§ 371 Date: May 12, 2016

(30) Foreign Application Priority Data
Nov. 15, 2013 (JP) 2013-237452
Aug. 28, 2014 (JP) 2014-173812

(51) Int. Cl. C09K 8/508; E21B 33/138; E21B 21/00

(52) U.S. Cl. CPC C09K 8/5086; C09K 8/508; E21B 21/003; E21B 33/138; E21B 43/11

(57) ABSTRACT

A temporary plugging agent for well drilling having a plugging function for a period of not greater than 40 days in a high-temperature environment having a temperature range between 93 and 204° C., and preferably, the above temporary plugging agent for well drilling (optionally formed from two or more types of plugging agents for well drilling) wherein a contained synthetic resin has a ratio of mass loss rate in 80° C. deionized water relative to the mass loss rate of polyglycolic acid of not less than 0.001 and less than 1, and/or has a compressive strength after a period of not greater than 40 days has elapsed at a temperature range between 93° C. and 204° C. of not less than 20% lower than the compressive strength before the period began; a well-treatment fluid comprising the temporary plugging agent for well drilling; and a method for well drilling in which a temporary plugging treatment is performed using the temporary plugging agent for well drilling.

### TECHNICAL FIELD

The present invention relates to a temporary plugging agent for well drilling and a method for well drilling used in well drilling for producing hydrocarbon resources such as petroleum or natural gas.

### BACKGROUND ART

Hydrocarbon resources such as petroleum (including shale oil and the like) or natural gas (including shale gas and the like) (sometimes collectively called “petroleum and the like” hereinafter) have been produced by excavation through wells (oil wells or gas wells, sometimes collectively called “wells” hereinafter) having a porous and permeable subterranean formation.

Well construction (also called “well drilling” hereinafter) is performed by, for example, the following processes. Specifically, construction of a well is completed via various processes, such as a drilling process in which a borehole is drilled using a drill in the vertical direction from the ground surface and, as necessary, in the horizontal direction; a casing process, which prevents disintegration of the borehole and prevents fluid from leaking through the inner wall of the borehole (well wall); a cementing process, which finishes the well wall; and a completion process, which includes a perforation process, in which the well wall is perforated for recovering petroleum and the like in the productive layer (subterranean formation that produces petroleum and the like; for example, a shale layer that produces shale gas and the like), and a fracturing process, which injects high-pressure fluid into the perforations to form and enlarge fractures in the well wall. Furthermore, repair of wells previously constructed is also performed via substantially the same processes as construction of a new well.

Various fluids are used in the well construction process, including various types of water-based, oil-based, and emulsion-based fluids.

In the drilling process, mud (sometimes called “drilling fluid” hereinafter) is circulated to remove the cuttings from the bottom (tip) of the well and around the drill, to lift up to above ground, to cool the drill and its surroundings to provide lubricity, and to prevent gushing by suppressing underground pressure. At this time, when mud escapes through the well wall during drilling or through fractures and the like present in the well wall, there is risk of causing disintegration of the well wall and furthermore, disintegration of the borehole, or of occurrence of unexpected infiltration of subterranean formation fluid. Thus, a lost circulation material (LCM), which plugs the well wall to prevent escape of mud from the well wall, is blended in the mud. As lost circulation materials (LCM), various inorganic materials and organic materials are used, such as: fibers such as cedar bark, sugar cane fibers, and mineral fibers; granules of limestone, marble, wood, walnut shells, cotton seed shells, corn cobs, synthetic resins, and the like; flakes of mica, resin film fragments, cellophane fragments, and the like; and the like.

In the perforation process and fracturing process, closed spaces are formed sequentially inside the borehole using pre-placed plug members such as frac plugs and frac sleeves, and the well wall is perforated by high-pressure fluid injected in the closed spaces, and fractures are further formed and enlarged (perforation is also sometimes performed using explosives). Thus, when the high-pressure fluid escapes from the well wall, the anticipated perforations and fractures cannot be formed because the anticipated fluid pressure cannot be achieved. Therefore, the well wall needs to be temporarily plugged. As the plug material, resin particles and the like are also sometimes used. Another method that has been employed is a fracturing method in which fracturing and plugging are sequentially repeated without using a plug member such as a plug. A further method that has been employed is a method in which recovery of petroleum and the like is again enabled by fracturing a different location by temporarily plugging a fracture that has been opened.

Additionally, outflow of petroleum and the like needs to be prevented and productivity needs to be improved by temporarily plugging fractures formed in the productive layer before flowback, in which the fracturing fluid is refluxed above ground. Furthermore, in cases where high-pressure fluid is injected to remove obstructions that remain in the well in order to begin production of petroleum and the like, if high-pressure fluid escapes from the well wall, the anticipated fluid pressure is not attained and the obstructions cannot be removed. When the well wall plugging function is lost before installation of equipment is complete, unexpected infiltration of subterranean formation fluid may occur. A plug is also sometimes called a bridge agent, and calcium carbonate and the like are often used.

Thus, in addition to various blended agents, temporary plugging agents, which temporarily plug the well wall, such as lost circulation materials (LCM) and diverting agents, are blended with the well-treatment fluid such as mud (drilling fluid), cementing fluid, perforation fluid, fracturing fluid, or completion fluid used in the processes mentioned above. Additionally, fluid for temporary plugging containing a temporary plugging agent is sometimes pumped into the borehole before these well-treatment fluids are pumped into the borehole.

It is desirable to remove these temporary plugging agents from the well wall so as not to hinder effusion of petroleum and the like when production of petroleum and the like is started. To do so, a fluid containing a material having a dissolving action on the temporary plugging agent, such as an acidic substance or alkaline substance, is sometimes injected inside the borehole.

Attempts have been made to make retrieval treatment and disposal treatment unnecessary and to reduce the expense and shorten the processes of well drilling by using a degradable material that degrades when a prescribed period has elapsed as a blended agent added for various purposes to well-treatment fluids such as mud (drilling fluid), cementing fluid, perforation fluid, fracturing fluid, or completion fluid.

U.S. Pat. No. 4,526,695A Specification (Patent Document 1) discloses a well fluid in which an aliphatic polyester solid that degrades in high-temperature water to be removed, is dispersed, for temporarily reducing the permeability of the subterranean productive layer penetrated by the well. U.S. Patent Application Publication No. 2004/0261996 A1 Specification (Patent Document 2) discloses a treatment fluid containing degradable particles such as degradable resin that can at least partially degrade in the presence of water. International Patent Application Publication No. WO/2012/050187 (Patent Document 3) discloses a dispersion for well drilling assistance used in well drilling for hydrocarbon resource recovery at relatively low temperatures (40 to 80° C.), and a fluidity control material comprising polyglycolic acid resin in fine solid form and having a prescribed molecular weight and a prescribed weight retention rate in 80° C. water.

U.S. Patent Application Publication No. 2006/0113077 A1 Specification (Patent Document 4) discloses a method for well treatment, in which in at least one of perforations, fractures, and boreholes penetrating a subterranean formation, plugs are formed by injecting a slurry containing a degradable material, and then downhole operations are performed, and then the plugging function is lost by means of the degradable material degrading at least partially after a selected period has elapsed. International Patent Application Publication No. WO/2013/161755 (Patent Document 5) discloses a well-treatment fluid such as drilling fluid and fracturing fluid having a function of preventing lost circulation, wherein the well-treatment fluid contains polyglycolic acid short fibers having a prescribed mass loss rate in 60° C. water.

Meanwhile, as energy consumption increases, deep underground where reserves are large, that is deeper wells are being constructed, reaching depths greater than 9000 m worldwide and greater than 6000 m in Japan. As well depth increases, well construction conditions and construction environments become harsh, and in particular, well treatment operations in high-pressure high-temperature (HPHT) environments are demanded. A HPHT environment in well construction is conventionally considered to be a region having a reservoir pressure of not less than 10,000 psi (690 atmospheric pressure) and a temperature of not less than 300° F. (149° C.).

As well depth has increased, it has become even more desirable to use degradable materials for various materials used, such as blended agents and the like contained in the well-treatment fluids, in an attempt to make retrieval treatment and disposal treatment unnecessary and to reduce the expense and shorten the processes of well drilling. Thus, a degradable material that satisfies the functions demanded in relatively high-temperature environments (sometimes called “high-temperature environments” hereinafter) such as HPHT environments is demanded.

As a temporary plugging agent such as a lost circulation material (LCM) or a diverting agent blended in a well-treatment fluid such as mud (drilling fluid), cementing fluid, perforation fluid, fracturing fluid, or completion fluid, a temporary plugging agent that has a plugging function for the required period during the processes of well drilling and that disappears by degrading after a prescribed period after the completion of the processes in a high-temperature environment such as, for example, an environment at a temperature of 93 to 204° C., has come to be in demand. However, among conventionally known degradable materials, a temporary plugging agent suitable for use in high-temperature environments has not been available. For example, the polyglycolic acid short fibers described in Patent Document 5 have a mass loss rate of not less than 10% after 14 days in 60° C. water, and a drilling fluid containing the polyglycolic acid short fibers as a lost circulation material has a function of preventing lost circulation which prevents penetration of the drilling fluid into a subterranean formation in a well at temperatures less than 150° C. for at least 3 hours. Thus, it provides a well-treatment fluid that is excellent in relatively low-temperature environments, but is not sufficient as a temporary plugging agent suitable for use in high-temperature environments.

Thus, it has been demanded that a temporary plugging agent for well drilling be provided, where the plug can reduce expenses and shorten processes of well drilling due to having a temporary plugging function suitable for use in high-temperature environments, based on the fact that excavation conditions have become more harsh and diverse such as the increased depth.

### CITATION LIST

### Patent Literature

Patent Document 1: U.S. Pat. No. 4,526,695A Specification

### Patent Document 2: U.S. Patent Application Publication No. 2004/0261996 A1 Specification

### Patent Document 3: WO/2012/050187

### Patent Document 4: U.S. Patent Application Publication No. 2006/0113077 A1 Specification

### Patent Document 5: WO/2013/161755

### SUMMARY OF INVENTION

### Technical Problem

The object of the present invention is to provide a temporary plugging agent for well drilling having a temporary plugging function (sometimes called “temporary plugging characteristics”) suitable for use in relatively high-temperature environments such as HPHT environments, which can reduce expenses and shorten processes of well drilling, under the circumstances that excavation conditions have become more harsh and diverse such as increased depth.

### Solution to Problem

As a result of diligent research to solve the above problems, the present inventors discovered that the problems can be solved by the use of a temporary plugging agent for well drilling containing synthetic resin having a plugging function for a prescribed period in a prescribed temperature environment, and thereby achieved the present invention.

Specifically, a first aspect of the present invention provides a temporary plugging agent for drilling containing synthetic resin having a plugging function for a period of not greater than 40 days at a temperature range between 93° C. (200° F.) and 204° C. (400° F.).

Furthermore, as specific modes of the invention, the first aspect of the present invention provides the temporary plugging agents for well drilling of (2) to (15) below.

(2) The temporary plugging agent for well drilling according to the above (1), wherein the plugging agent has a plugging function for a period of not less than 2 days and not greater than 40 days.

(3) The temporary plugging agent for well drilling according to the above (1) or (2), wherein a compressive strength of the synthetic resin after the period of not greater than 40 days at a temperature range between 93° C. (200° F.) and 204° C. (400° F.) is not less than 20% lower than the compressive strength before the period began. (4) The temporary plugging agent for well drilling according to any one of above (1) to (3), wherein mass loss rate in 80° C. deionized water of the synthetic resin is a ratio of not less than 0.001 and less than 1 relative to a mass loss rate of polyglycolic acid. (5) The temporary plugging agent for well drilling according to the above (3) or (4), wherein the synthetic resin comprises at least one type selected from the group consisting of polyurethane, polylactic acid, aromatic polyester, aliphatic polyamide, and polycarbonate.

(6) The temporary plugging agent for well drilling according to any one of the above (3) to (5), wherein the synthetic resin comprises at least one type selected from the group consisting of thermoplastic polyurethane, stereocomplex polylactic acid, polylactic acid containing a hydrolysis inhibitor, and aromatic polyester.

(7) The temporary plugging agent for well drilling according to any one of the above (3) to (6), wherein the synthetic resin comprises at least one of a polybutylene adipate terephthalate random copolymer and an unsaturated polyester.

(8) The temporary plugging agent for well drilling according to any one of the above (3) to (7), wherein the synthetic resin comprises a polyglycolic acid-based resin.

(9) The temporary plugging agent for well drilling according to any one of the above (1) to (8), wherein the plug is formed from not less than two types of plugging agents for well drilling.

(10) The temporary plugging agent for well drilling according to the above (9), wherein all of the not less than two types of plugging agents for well drilling are temporary plugging agents for well drilling containing synthetic resin having a plugging function for a period of not greater than 40 days at a temperature range between 93° C. (200° F.) and 204° C. (400° F.).

(11) The temporary plugging agent for well drilling according to the above (9) or (10), wherein the not less than two types of plugging agents for well drilling comprise different synthetic resins.

(12) The temporary plugging agent for well drilling according to any one of the above (9) to (11), wherein the not less than two types of plugging agents for well drilling differ in at least one of shape and size.

(13) The temporary plugging agent for well drilling according to any one of the above (1) to (12), wherein the plugging agent disappears by dissolving or degrading by contacting a hydrocarbon resource produced from a well.

(14) The temporary plugging agent for well drilling according to any one of the above (1) to (13), wherein the plugging agent is used in one or a plurality of processes among a drilling process, a cementing process, a perforation process, a fracturing process, and a completion process.

(15) The temporary plugging agent for well drilling according to any one of the above (1) to (14), wherein the plugging agent is a lost circulation material or a diverting agent.

Additionally, another aspect of the present invention provides: (16) A well-treatment fluid comprising the temporary plugging agent for well drilling described in any one of the above (1) to (15). As a specific mode of the invention, another aspect of the present invention provides: (17) The well-treatment fluid according to the above (16), wherein the fluid is at least one type selected from the group consisting of a drilling fluid, a cementing fluid, a fracturing fluid, and a completion fluid.

Yet another aspect of the present invention provides: (18) A method for well drilling including performing temporary plugging using the temporary plugging agent for well drilling described in any one of the above (1) to (15). As specific modes of the invention, yet other aspects of the present invention provide the methods for well drilling of (19) to (21) below.

(19) The method for well drilling according to the above (18), wherein the temporary plugging agent for well drilling described in any one of the above (1) to (15) is used in one or a plurality of processes among a drilling process, a cementing process, a perforation process, a fracturing process, and a completion process.

(20) The method for well drilling according to the above (18) or (19), wherein a plugging agent for well drilling having a plugging function for a period of greater than 40 days at a temperature range between 93° C. (200° F.) and 204° C. (400° F.) is used together with the temporary plugging agent for well drilling described in any one of the above (1) to (15).

(21) The method for well drilling according to any one of the above (18) to (20), wherein, after temporary plugging is performed using the temporary plugging agent for well drilling described in any one of the above (1) to (15), the plugging agent is released by contacting a material that can degrade the temporary plugging agent for well drilling.

### Advantageous Effects of Invention

The first aspect of the present invention exhibits the effect of providing a temporary plugging agent for well drilling that can reduce expenses and shorten processes of well drilling due to having a temporary plugging function suitable for use in high-temperature environments such as HPHT environments, under the circumstances that excavation conditions have become more harsh and diverse such as increased depth. This can be achieved by the temporary plugging agent for well drilling comprising a synthetic resin having a plugging function for a period of not greater than 40 days, and in many cases not less than 2 days and not greater than 40 days, at a temperature range between 93° C. (200° F.) and 204° C. (400° F.) (sometimes denoted as simply “93 to 204° C.” hereinafter), and in particular, a temporary plugging agent for well drilling containing synthetic resin having a plugging function for a period of not greater than 40 days at 93 to 204° C., and/or the above temporary plugging agent for well drilling wherein the contained synthetic resin has a ratio of mass loss rate in 80° C. deionized water of not less than 0.001 and less than 1 relative to the mass loss rate in polyglycolic acid, and also has a compressive strength after a period of not greater than 40 days has elapsed at a temperature range between 93° C. (200° F.) and 204° C. (400° F.) of not less than 20% lower than the compressive strength before the period began.

Furthermore, another aspect of the present invention exhibits the effect of providing a well-treatment fluid that can reduce expenses and shorten processes of well drilling due to having a temporary plugging function suitable for use in high-temperature environments, under the circumstances that excavation conditions have become more harsh and diverse such as increased depth. This can be achieved by the well-treatment fluid comprising the above temporary plugging agent for well drilling. Additionally, yet another aspect of the present invention exhibits the effect of providing a method for well treatment that can reduce expenses and shorten processes of well drilling due to having a temporary plugging function suitable for use in high-temperature environments, under the circumstances that excavation conditions have become more harsh and diverse such as increased depth. This can be achieved by the method for well treatment including performing temporary plugging using the above temporary plugging agent for well drilling.

### DESCRIPTION OF EMBODIMENTS

The present invention relates to a temporary plugging agent for well drilling, a well-treatment fluid, and a method for well drilling used in well drilling performed to produce petroleum and the like.

I. A temporary plugging agents for drilling containing synthetic resin having a plugging function for a period of not greater than 40 days at a temperature range between 93° C. (200° F.) and 204° C. (400° F.).

The temporary plugging agent for well drilling according to the first aspect of the present invention is a temporary plugging agent for well drilling containing synthetic resin having a plugging function for a period of not greater than 40 days, and in many cases not less than 2 days and not greater than 40 days, at a temperature range between 93 and 204° C., and in particular, a temporary plugging agent for well drilling containing synthetic resin having a plugging function for a period of not greater than 40 days at 93 to 204° C., and preferably, the above temporary plugging agent for well drilling wherein the contained synthetic resin has a ratio of mass loss rate in 80° C. deionized water relative to a mass loss rate of polyglycolic acid of not less than 0.001 and less than 1, and/or has a compressive strength after a period of not greater than 40 days has elapsed at a temperature of 93 to 204° C. of not less than 20% lower than the compressive strength before the period began. Thus, as will be described in detail later, it is a degradable temporary plugging agent for well drilling containing synthetic resin having the property of losing the plugging function within a period of not greater than 40 days at a temperature range between 93 and 204° C. In other words, the temporary plugging agent for well drilling of the present invention is a temporary plugging agent for well drilling comprising a degradable synthetic resin that has a plugging function for a period of not greater than 40 days at a temperature range between 93 and 204° C., and loses the plugging function within that period. The period for which it has a plugging function at a temperature range between 93 and 204° C. is, in many cases, not less than 2 days and not greater than 40 days, but, for example, in some fracturing processes, there is also a need for the temporary plugging function to be released in 30 minutes to 1 hour in an environment at a temperature range between 93 and 204° C. The temporary plugging agent for well drilling containing synthetic resin of the present invention is capable of meeting that need.

1. Temporary Plugging Agent for Well Drilling

In the present invention, a temporary plugging agent for well drilling means a material used as a blended agent contained in a well-treatment fluid for the purpose of temporarily plugging a well wall in the various processes of well drilling (well construction), specifically the drilling process, cementing process, perforation process, fracturing process, or completion process. For example, it means a blended agent material called a lost circulation material (LCM), a perforation plugging agent, a temporary plugging agent for fracturing (diverting agent), a bridging agent (sometimes called a “completion plug”), and the like.

2. Temporary Plugging Agent for Well Drilling Containing Synthetic Resin

The temporary plugging agent for well drilling of the present invention is a temporary plugging agent for well drilling containing synthetic resin. Specifically, conventional temporary plugging agents such as lost circulation materials use various inorganic materials and organic materials, such as: fibers such as cedar bark, sugar cane fibers, and mineral fibers; granules of limestone, marble, wood, walnut shells, cotton seed shells, corn cobs, synthetic resins, and the like; flakes of mica, resin film fragments, cellophane fragments, and the like; and the like. However, a feature of the temporary plugging agent for well drilling of the present invention is that it contains a synthetic resin. The synthetic resin is not particularly limited as long as it is a degradable resin capable of having a plugging function for a prescribed period and then losing the plugging function in a high-temperature environment, but it preferably does not melt in a high-temperature environment. Examples of preferred degradable synthetic resins include polyurethane, polylactic acid, aliphatic polyester, aromatic polyester, aliphatic polyamide, polycarbonate, and the like. Among these resins, one having a plugging function for the prescribed period in a high-temperature environment may be selected.

3. Degradable Synthetic Resin, and Compressive Strength Decrease of Synthetic Resin

In the temporary plugging agent for well drilling containing synthetic resin of the present invention, a degradable synthetic resin capable of losing a plugging function means: i) a degradable synthetic resin in the strict sense, which degrades to the level of carbon dioxide and water via decomposition of the resin molecular structure, as in, for example, polyglycolic acid (sometimes called “PGA” hereinafter); ii) a degradable synthetic resin that loses the plugging function by losing strength and degrading via a decrease in molecular weight due to the molecular chain scission of the resin or the like (in this case, the mass of the material does not always decrease); iii) a degradable synthetic resin that loses strength and loses the plugging function by being dispersed in a solvent such as water, due to the material containing the resin being made finer or made into a finer powder relative to its initial shape (in this case, the mass of the material does not always decrease); iv) a degradable synthetic resin that loses strength and loses the plugging function due to the resin contained in the material dissolving into a solvent such as water; and the like. As the synthetic resin contained in the temporary plugging agent for well drilling of the present invention, a preferred synthetic resin is one having a compressive strength after a period of not greater than 40 days, and in many cases not less than 2 days and not greater than 40 days, at a temperature range between 93° and 204° C. of not less than 20% lower than the compressive strength before the period began. The compressive strength decrease ratio is more preferably not less than 25%, and even more preferably not less than 30%. Compressive strength may be determined by measurement according to JIS K7181 (conforming to ISO 604) at a prescribed temperature (a temperature determined in advance depending on objective) within a range of 93 to 204° C. Furthermore, the upper limit of the above compressive strength decrease ratio is 100%, and if the synthetic resin dissolves or elutes out and loses its shape or disappears before a period of 40 days has elapsed at 93 to 204° C., or, if its compressive strength cannot be measured, the above compressive strength decrease ratio is taken to be 100%.

The temporary plugging agent for well drilling of the present invention exhibits a temporary plugging function in a high-temperature environment of a temperature range between 93 and 204° C. For reference, the compressive strength decrease ratios for several synthetic resins in an environment of a temperature lower than 93° C., specifically at 80° C., will be presented. Specifically, the compressive strength decrease ratios when immersed in 80° C. deionized water for a prescribed time are shown in Table 1 for the following synthetic resins: PGA; polylactic acid (sometimes called “PLA” hereinafter); thermosetting polyurethane (durometer type A hardness (conforming to ISO 7619) 82°, sometimes denoted as “thermosetting PU (A82)” hereinafter); a composition of thermosetting polyurethane (A82) containing 5% by mass of glycolide, which is a degradation accelerator to be described later (sometimes denoted as “thermosetting PU (A82) (containing 5% glycolide)” hereinafter); and polybutylene adipate terephthalate random copolymer (sometimes called “PBAT” hereinafter).

TABLE 1

| | | | Compressive |
|---|---|---|---|
| | | | strength |
| | Temperature | Elapsed time | decrease ratio |
| Synthetic resin or the like | (° C.) | (days) | (%) |
| PGA | 80 | 0.79 (19 hr) | 59 |
| PLA | 80 | 1 | 38 |
| Thermosetting PU (A82) | 80 | 3 | 2 |
| | | 7 | 17 |
| | | 14 | 42 |
| Thermosetting PU (A82) | 80 | 1 | 55 |
| (containing 5% glycolide) | | 7 | 92 |
| PBAT | 80 | 7 | −17 |
| | | 14 | 24 |

From Table 1, since PGA, PLA, and thermosetting PU (A82) (containing 5% glycolide) decrease in compressive strength by not less than 20% after approximately 1 day at 80° C., it is considered that they would have difficulty exhibiting a plugging function over a period of, for example, not less than 1 day, at a higher temperature range between 93 and 204° C. Thus, they can be evaluated unsuitable as temporary plugging agents for well drilling for plugging for a period of not less than 1 day. However, as was described above, these synthetic resins can be employed when there is a need for the temporary plugging function to be released in 30 minutes to 1 hour in an environment at 93 to 204° C. On the other hand, thermosetting PU (A82) and PBAT have a compressive strength decrease ratio of less than 20% and can continue to exhibit a plugging function even after 7 days at 80° C. Thus, they may be considered usable as a temporary plugging agent for well drilling having a plugging function for a period of not greater than 40 days even in a higher-temperature environment of 93 to 204° C.

Here, the process of demonstrating a temporary plugging function (plugging function and plug release function) required for a temporary plugging agent for well drilling will be further described. Specifically, in the synthetic resin contained in a temporary plugging agent that exhibits a plugging function under a certain load, when the strength (typically, compressive strength is used as an indicator) decreases due to resin degradation or molecular weight decrease, and the strength decrease ratio (specifically, the compressive strength decrease ratio) is greater than 20%, a part of the contact area between the temporary plugging agent and the plugged object (for example, the inner wall of a borehole or the like) does not withstand the pressure (compressive pressure or tensile pressure, or the like), and the plug is released due to deformation or disintegration. Furthermore, in a surface-degrading type of resin such as PGA, the strength decrease ratio of the surface is markedly higher than the strength decrease ratio of the overall body, and therefore, it is assumed that even when the strength decrease ratio of the overall body is not greater than 20%, the surface part that is the aforementioned contact surface does not withstand pressure and cannot maintain a plug. Furthermore, with a synthetic resin that releases acid as it degrades, like PGA, it can also be deduced that the viscosity of the well-treatment fluid such as mud decreases, which has the effect of triggering release of the plug (a function as a gel breaker). Thus, the synthetic resin contained in the temporary plugging agent for well drilling of the present invention preferably has a compressive strength after a period of not greater than 40 days has elapsed at a temperature range between 93° C. (200° F.) and 204° C. (400° F.), of not less than 20% lower than the compressive strength before the period began.

The general relationship between the temporary plugging function required for a temporary plugging agent for well drilling and the molecular weight, a basic property of a synthetic resin will be described. Specifically, for PGA having an initial molecular weight (weight average molecular weight; sometimes denoted as “initial MW” hereinafter) of 200,000 and an initial compressive strength (sometimes denoted as “initial strength” hereinafter) of 146 MPa, when the temporary plugging function during immersion in 80° C. or 100° C. deionized water was tested in conformance with the testing method for a temporary plugging function described later, the plug was released in 19 hours at 80° C. and in 5 hours at 100° C. (this time duration is sometimes denoted as “plug maintenance time”; units: hours). At 80° C., the molecular weight of PGA when the plugging was released was 72,000, and the compressive strength was 86 MPa (a decrease ratio of 41% relative to its initial strength). Table 2 shows the test results of the time at which the plug was released when the initial molecular weight of PGA were changed to 100,000 or 50,000, together with the initial strength (units: MPa) and the decrease ratio of initial strength of PGA having various initial molecular weights relative to the initial strength of PGA having an initial MW of 200,000 (sometimes denoted as “initial strength decrease ratio” hereinafter; units: %).

TABLE 2

| | | Decrease ratio relative | Plug maintenance | |
|---|---|---|---|---|
| | Initial strength | to the initial strength | time (hours) | |
| Initial MW | (MPa) | (%) | 80° C. | 100° C. |
| 200,000 | 146 | — | 19 | 5 |
| 100,000 | 134 | 8 | 12 | 3 |
| 50,000 | 49 | 66 | 9 | 1.5 |

From Table 2, it can be deduced that a certain degree of plugging function is exhibited even by PGA having an initial MW of 50,000. This PGA has a molecular weight lower than 72,000 and compressive strength lower than 86 MPa, which were the values of PGA having an initial MW of 200,000 when the plugging function was lost. Thus, it is estimated that PGA having a low initial MW, even though it is a synthetic resin having a low initial MW and low initial strength, will demonstrate a plugging function through appropriate rearrangement of the synthetic resin material having a shape such as pellets, powder, or flakes. In other words, it is suggested that release of the plug occurs due to a decrease from the initial material characteristics of the plug. On the other hand, when it is assumed that the plug maintenance time tends to be shorter when the initial material characteristics are low, and it is also assumed that a well environment where a temporary plugging function is required is a high-temperature high-pressure environment, it is contemplated to be substantially impossible for the synthetic resin material to be rearranged so as to exhibit a plugging function again, once the plug has been released. Thus, usually, a molecular weight and the like for a synthetic resin that can be used as a temporary plugging agent for well drilling need to be selected appropriately.

4. Mass Loss Rate of Synthetic Resin in 80° C. Deionized Water

As a useful criterion for selecting a synthetic resin having a plugging function for a prescribed period in a high-temperature environment, it is preferable to select a synthetic resin having a ratio of mass loss rate in 80° C. deionized water relative to the mass loss rate of PGA is not less than 0.001 and less than 1. PGA is a synthetic resin known to be degradable even in relatively low-temperature environments. As long as it is a synthetic resin having the ratio of the mass loss rate in 80° C. deionized water (sometimes called “mass loss rate in 80° C. water” hereinafter) relative to the mass loss rate in 80° C. water of PGA (sometimes called “PGA-relative mass loss rate ratio” hereinafter) being not less than 0.001 and less than 1, it is easy to obtain the temporary plugging agent for well drilling containing synthetic resin of the present invention having a plugging function for a period of not greater than 40 days, and in many cases not less than 2 days and not greater than 40 days, at a temperature range between 93 and 204° C., by adjusting the physical properties (molecular weight, degree of crosslinking, crystal structure, crystallinity, and the like) and composition of the synthetic resin as well as the combination of shape and size, as will be described later. Furthermore, it is easy to achieve a temporary plugging period that satisfies the required temporary plugging period depending on the application such as, for example, 3, 5, 7, 14, 21, or 35 days.

The mass loss rate in 80° C. deionized water of a synthetic resin is determined by immersing 3 g of the synthetic resin particles, which is contained in the temporary plugging agent for well drilling, in 50 g of 80° C. deionized water for 21 days, and calculating the ratio of the mass of the synthetic resin after immersion relative to the mass of the synthetic resin before immersion, and then further comparing this to the mass loss rate in 80° C. water of PGA (molecular weight from 70,000 to 500,000). When the PGA-relative mass loss rate ratio of the synthetic resin is too low, degradation and strength loss of the synthetic resin do not proceed even in a period greater than 40 days at a temperature range between 93 and 204° C., and as a result, it may not lose its plugging function and there is risk of not being able to shorten the processes of well drilling because the temporary plugging agent remains in the borehole even after the plugging function is no longer necessary in the high-temperature environment. When the PGA-relative mass loss rate ratio of the synthetic resin is too high, the plugging function may be lost in a period such as, for example, 30 minutes to 1 hour or in less than 2 days at 93 to 204° C., and the plugging function may be lost before the period for which the plugging function is required in the high-temperature environment has elapsed. From the perspective that it is easy to adjust the period for which the temporary plugging agent for well drilling has a temporary plugging function in a high-temperature environment, the PGA-relative mass loss rate ratio of the temporary plugging agent for well drilling containing synthetic resin of the present invention is more preferably not less than 0.0015 and not greater than 0.3, even more preferably not less than 0.002 and not greater than 0.13, and particularly preferably not less than 0.005 and not greater than 0.1.

The process of demonstrating the mass loss and temporary plugging function (plugging function and plug release function) of a temporary plugging agent for well drilling will be further described. Specifically, as the mass of a temporary plugging agent for well drilling decreases, the volume of the temporary plugging agent for well drilling decreases and a gap occurs in the plugged space, and the plug is thereby released. Release of the plug occurs at either one or both of the locations where the above gap is produced and the contact interface of the synthetic resin contained in the temporary plugging agent for well drilling with the inner wall of the downhole or the outer circumferential surface of the mandrel or the like, caused by disintegration of the plugged portions due to a strength decrease. This action mechanism is an effect that occurs for surface-degrading types of resin such as PGA. Furthermore, there are also cases where the plugged part disintegrates and the plug is released due to decrease in strength (compressive strength decreasing not less than 20%, or the like) as described above, even though the mass of the synthetic resin contained in the temporary plugging agent for well drilling does not markedly decrease. Such an action is a phenomenon that typically occurs in bulk-degrading synthetic resins, and is an active mechanism seen in, for example, polyurethane, PLA, and the like. For example, as will be described later, it has been confirmed that no fine particles of polyurethane remains after a temporary plugging agent for well drilling that contains polyurethane degrades at high temperature and the plugging function is released. This has an advantage that there is no obstacle to production of hydrocarbon resources produced from the well.

Synthetic Resin

The above synthetic resin having a ratio of compressive strength decrease of not less than 20%, and preferably having a PGA-relative mass loss rate ratio of not less than 0.001 and less than 1, is not particularly limited, but examples include a synthetic resin containing at least one type selected from polyurethane, PLA, aromatic polyester, aliphatic polyamide, and polycarbonate, or synthetic resin containing at least one of PBAT and unsaturated polyester. The PGA-relative mass loss rate ratios of these synthetic resins are known to be as follows. Specifically, among polyurethanes, for thermosetting polyurethane PGA-relative mass loss rate ratio is from 0.35 to less than 1, and for thermoplastic polyurethane it is from 0.005 to 0.1; among PLAs, for poly-L-lactic acid it is from 0.1 to 0.3, and for stereocomplex polylactic acid it is from 0.02 to 0.06; among aromatic polyesters, for polybutylene terephthalate it is from 0.005 to 0.05; and among aliphatic polyamides, for nylon 66 it is from 0.002 to 0.01. Furthermore, it is known that polycarbonate has a PGA-relative mass loss rate ratio of 0.002 to 0.01. It is also known that the PGA-relative mass loss rate ratio of PBAT is from 0.008 to 0.08, and among unsaturated polyesters, it is known that there are unsaturated polyesters derived from maleic anhydride having a PGA-relative mass loss rate ratio of 0.002 to 0.05 and a mass loss rate after 40 days in 100° C. water of not less than 20%. These synthetic resins include those having a satisfactory compressive strength decrease ratio at 93 to 204° C. described above. For example, for thermosetting polyurethane, although the PGA-relative mass loss rate ratio is not necessarily low, after a period of not greater than 40 days at 93 to 204° C. its compressive strength decreases not less than 20% relative to the compressive strength before the period began.

Judging from the compressive strength decrease ratio and the PGA-relative mass loss rate ratio described above, a temporary plugging agent for well drilling containing at least one type selected from the group consisting of thermoplastic polyurethane, stereocomplex polylactic acid, polylactic acid containing a hydrolysis inhibitor, and aromatic polyester is more preferably used for the temporary plugging agent for well drilling containing synthetic resin of the present invention. The synthetic resins will be further described.

(1) Polyurethane

As described above, due to the fact that polyurethane, and above all thermoplastic polyurethane, has a PGA-relative mass loss rate ratio of 0.005 to 0.1, it is easy to control the temporary plugging ability and corresponding degradability and disintegrability. Thus, it is a particularly preferred synthetic resin for the temporary plugging agent containing synthetic resin for well drilling of the present invention. A particularly preferred thermoplastic polyurethane contained in the temporary plugging agent for well drilling containing synthetic resin is a polyurethane having a urethane bond (—NH—CO—O—) in the molecule, typically obtained by condensing an isocyanate compound and a compound containing a hydroxyl group. With regard to the compound containing a hydroxyl group, thermoplastic polyurethanes can be broadly classified into polyester-type polyurethanes containing an ester bond in the main chain thereof, and polyether-type polyurethanes containing an ether bond in the main chain thereof. Either of these types may be used. Both crosslinked type and uncrosslinked type may be used. However, polyester-type polyurethane is often more preferred because it is easier to control the temporary plugging ability and corresponding degradability and disintegrability by adjusting the degree of crosslinking and the hardness. As thermoplastic polyurethanes, both thermoplastic polyurethane elastomers having rubber elasticity and thermoplastic polyurethanes that do not have rubber elasticity may be used. In many cases, thermoplastic polyurethane elastomers are elastic bodies having both the elasticity (flexibility) of synthetic rubber and the rigidity (solidity) of plastic. They are generally known to have excellent abrasion resistance, chemical resistance, and oil resistance, high mechanical strength (compressive strength and the like), and high elasticity with high energy absorbency, and they are sometimes suitable for the temporary plugging agent for well drilling of the present invention. Additionally, because thermoplastic polyurethane elastomers maintain plugging ability for a longer period through deformation due to their rubber elasticity and the like, temporarily plugging ability can sometimes be more easily adjusted. Furthermore, among polyurethanes, thermosetting polyurethane may be preferably used as the temporary plugging agent for well drilling of the present invention by selecting the material and composition thereof, and the like.

Preferably, in a polyurethane having a PGA-relative mass loss rate ratio of 0.005 to 0.01, in order to further reduce PGA-relative mass loss rate ratio as desired, i.e., in order to decrease degradability to within a desired range, adjustments can be made based on the perspectives (i) to (vi) below, for example.

(i) In general, it tends to be easier to reduce the PGA-relative mass loss rate ratio of thermoplastic polyurethane than thermosetting polyurethane.
(ii) The PGA-relative mass loss rate ratio of thermoplastic polyurethane can be reduced by increasing hardness.
(iii) The PGA-relative mass loss rate ratio of thermoplastic polyurethane can be further reduced by forming a crosslinked structure by crosslinking in the polymerization step or by adding a crosslinking agent or the like in the processing step.
(iv) The PGA-relative mass loss rate ratio decreases as the added amount of crosslinking agent increases, up to 10 parts by mass relative to 100 parts by mass of polyurethane, and the PGA-relative mass loss rate ratio can be further reduced by adding a crosslinking agent in an amount greater than 10 parts by mass (normally not greater than 30 parts by mass, and in many cases not greater than 25 parts by mass).
(v) An example of the crosslinking method is melt-kneading using a crosslinking agent such as a polyfunctional isocyanate compound, polyfunctional amine compound, or polyfunctional epoxy compound. Examples of the polyfunctional isocyanate compound include hexamethylene diisocyanate, xylylene diisocyanate, tolylene diisocyanate, 4,4′-diphenylmethane diisocyanate, 1,5-naphthalene diisocyanate, and the like. Examples of the polyfunctional amine compound include 3,3′-dichlorobenzidine, 4,4′-methylenebis-2-chloroaniline, trimethylenebis(4-aminobenzoate), and the like. Examples of the polyfunctional epoxy compound include tris(2,3-epoxypropyl)isocyanurate, poly(glycidyl methacrylate), and the like.
(vi) As another example of the crosslinking method, the PGA-relative mass loss rate ratio can be further reduced by energy ray crosslinking such as electron beam crosslinking (acceleration voltage normally in the range of 10 to 300 kV, and in many cases 15 to 200 kV) using a polyfunctional unsaturated group-containing crosslinking agent (for example, a polyfunctional (meth)acrylate-based monomer having two or more ethylenically unsaturated bonds in the molecule or the like, specific examples of which include ethylene glycol di(meth)acrylate, propylene glycol di(meth)acrylate, trimethylol propane tri(meth)acrylate, dipentaerythritol tri(meth)acrylate, dipentaerythritol hexa(meth)acrylate, and the like).

Based on one or a combination of these perspectives, it is possible to obtain a polyurethane of which the PGA-relative mass loss rate ratio is in the desired range of 0.005 to 0.1.

Specific examples of particularly preferred thermoplastic polyurethanes include lactone-based polyester-type polyurethane (crosslinked type) having a durometer type D hardness (conforming to ISO 7619) of 74°, polyester-type urethane rubber (crosslinked type) having a durometer type A hardness (conforming to ISO 7619) of 95°, lactone-based polyester-type urethane rubber (uncrosslinked type) having a durometer type D hardness (conforming to ISO 7619) of 74°, polyester-type urethane rubber (uncrosslinked type) having a durometer type A hardness (conforming to ISO 7619) of 85°, and the like.

The ratio by which the compressive strength decreases after a specified time has elapsed when immersed in deionized water of various temperatures (sometimes called “compressive strength decrease ratio” hereinafter) for the various polyurethanes including the above specific examples of thermoplastic polyurethane is shown in Table 3. Note that the list of synthetic resins and the like conforms to the previous Table 1.

TABLE 3

| | | | Compressive |
|---|---|---|---|
| Tem- | | Elapsed | strength |
| perature | | time | decrease ratio |
| (° C.) | Synthetic resin or the like | (days) | (%) |
| 93 | Thermosetting PU (A82) | 1 | −15 |
| | | 3 | 27 |
| | | 7 | 84 |
| | Thermosetting PU (A90) | 1 | 15 |
| | | 3 | 19 |
| | | 7 | 72 |
| | | 14 | 90 |
| | Thermoplastic PU (A85) | 1 | 2 |
| | | 3 | 5 |
| | | 7 | 11 |
| 120 | Thermosetting PU (A82) | 0.25 | 39 |
| | | 0.5 | 51 |
| | | 1 | 94 |
| | Thermoplastic PU (A85) | 0.25 | 22 |
| | | 1 | 29 |
| | | 3 | 94 |
| | Thermoplastic PU (A85) | 1 | 19 |
| | (containing 10 phr crosslinking agent) | 2 | 27 |
| | | 3 | 70 |
| | Thermoplastic PU (A95) | 1 | 11 |
| | (containing 10 phr crosslinking agent) | 3 | 18 |
| 149 | Thermoplastic PU (D74) | 0.25 | 0 |
| | (containing 10 phr crosslinking agent) | 0.5 | 24 |
| | Thermoplastic PU (A85) | 0.04 | 19 |
| | | 0.25 | 21 |
| | Thermoplastic PU (A85) | 0.25 | 27 |
| | (containing 10 phr crosslinking agent) | 1 | 97 |
| | Thermoplastic PU (A95) | 0.25 | 48 |
| | (containing 10 phr crosslinking agent) | 0.5 | 88 |

The following are deduced from Table 3. Specifically, since thermoplastic polyurethane maintains a state of low compressive strength decrease even after, for example, 7 days at 93° C., it can be considered a synthetic resin that may be more applicable as a temporary plugging agent for well drilling used in a high-temperature region (for example, temperature 120° C., 149° C., or the like), as compared with thermosetting polyurethane. The reason that thermoplastic polyurethane has significantly higher water resistance and heat resistance than thermosetting polyurethane is not necessarily clear, but it is assumed that aggregation of hard segments and the like may have an effect. Additionally, when thermoplastic polyurethane contains a crosslinking agent, the period after which its compressive strength decreases can be up to twice as long as that of a thermoplastic polyurethane that does not contain a crosslinking agent (according to a comparison between the compressive strength decrease ratio of thermoplastic PU (A85) after 1 hour at 120° C. and the compressive strength decrease ratio of thermoplastic PU (A85) containing 10 phr crosslinking agent after 2 days, and the like). Thus, it is deduced that it is possible to obtain a temporary plugging agent for well drilling containing a polyurethane having a plugging function for about 1 to 4 weeks at 120° C. by selecting a polyurethane that can be employed at a higher temperature due to formation of a crosslinked structure through the addition of a crosslinking agent or the like, and that has a further increased degree of crosslinking through a combination of increased crosslinking agent content and use of electron beam crosslinking, and that has high hardness for a polyurethane. Note that the effect of crosslinking on plugging function is not consistent and depends on the type of synthetic resin or the circumstances of the well environment such as temperature.

(2) Stereocomplex Polylactic Acid, Polylactic Acid Containing Hydrolysis Inhibitor, Aromatic Polyester, Aliphatic Polyamide, and Polycarbonate

A synthetic resin having a PGA-relative mass loss rate ratio of not less than 0.005 and not greater than 0.1 is a synthetic resin that is particularly preferably contained in the temporary plugging agent for well drilling containing synthetic resin of the present invention. Specific examples include stereocomplex polylactic acid, which is known to have high heat resistance and is obtained by mixing poly-L-lactic acid and poly-D-lactic acid to form a stereocomplex by means of the respective polymer chains advantageously meshing together; and polylactic acid containing a hydrolysis inhibitor such as carbodiimide, and preferably cyclic carbodiimide (known to have improved heat resistance). An example of the aromatic polyester is polybutylene terephthalate, but examples also include copolymers of aromatic polyesters (which may be copolymers with aliphatic polyesters). Specifically, polybutylene adipate terephthalate random copolymer (PBAT) and the like are particularly preferred synthetic resins (the compressive strength decrease ratio when PBAT is immersed for a prescribed duration in 93° C. or 107° C. deionized water is shown in Table 4.).

TABLE 4

| | | Elapsed | Compressive strength |
|---|---|---|---|
| | Temperature | time | decrease ratio |
| Synthetic resin or the like | (° C.) | (days) | (%) |
| PBAT | 93 | 3 | −17 |
| | | 7 | 52 |
| | 107 | 1 | −23 |
| | | 3 | 74 |

Furthermore, aliphatic polyamide and polycarbonate are examples of synthetic resins having a stable PGA-relative mass loss rate ratio of not less than 0.002 and not greater than 0.13 that are more preferably contained in the temporary plugging agent for well drilling containing synthetic resin of the present invention. More specifically, examples of the aliphatic polyamide include nylon 4, nylon 6, nylon 66, nylon 6-66, nylon 10, and polyamino acids such as polyaspartic acid, and the like. Examples of the polycarbonate include cyclic polycarbonates such as polytrimethylene carbonate, and aliphatic polyester carbonates, and the like.

(3) Unsaturated Polyester

Unsaturated polyester is another synthetic resin preferably contained in the temporary plugging agent for well drilling of the present invention. Unsaturated polyester is a resin obtained by crosslinking a vinyl group-containing polyester obtained by condensation-reaction of a polycarboxylic acid and a polyhydric alcohol, at least one of which contains an unsaturated group, with a vinyl-based monomer. As the polycarboxylic acid, unsaturated dicarboxylic acids such as fumaric acid, maleic acid, itaconic acid, citraconic acid, and nadic acid (3,6-endomethylene-tetrahydrophthalic acid) or anhydrides thereof may be used, among which fumaric anhydride and maleic anhydride are preferred. Furthermore, saturated dicarboxylic acids such as terephthalic acid, isophthalic acid, and sulfoisophthalic acid, or salts (ammonium salts, and the like) or anhydrides and so forth thereof, may be used in combination. Examples of the polyhydric alcohol that may be used include alkylene glycols such as ethylene glycol, propylene glycol, 2,3-butanediol, 1,4-butanediol, 1,5-pentanediol, 1,6-hexanediol, neopentyl glycol, 2,2,4-trimethyl-1,3-pentanediol; polyoxyalkylene glycols such as diethylene glycol, dipropylene glycol, polyethylene glycol, polypropylene glycol, and polytetramethylene glycol; bisphenols such as bisphenol A; and the like. As alcohols that are tertiary and above, trimethylol ethane, trimethylol propane, glycerin, pentaerythritol, and the like may be used in combination. As the polyhydric alcohol, ethylene glycol, propylene glycol, or 2,3-butanediol are preferred. Examples of the vinyl monomer serving as the crosslinking agent include unsaturated monocarboxylic acids or derivatives thereof such as styrene and alkyl-substituted compounds thereof, methyl methacrylate, methacrylic acid, and acrylamide; allyl compounds such as diallyl phthalate and triallyl isocyanurate; and the like. Styrene or methyl methacrylate is preferred. Unsaturated polyester can be considered a highly designable synthetic resin for forming a temporary plugging agent for well drilling, because its plugging ability and degradability in a diversity of well environments can be adjusted by selecting the polycarboxylic acid such as saturated dicarboxylic acid or anhydrides thereof, the polyhydric alcohol, and the type and content of crosslinking agent, and by selecting the shape and size (e.g., diameter of particles and the like). Furthermore, unsaturated polyester forms a water-insoluble component such as polystyrene when degraded, and although it may remain, polystyrene does not carry the risk of hindering production because it dissolves when it contacts a hydrocarbon resource such as petroleum or natural gas produced from the well after the well drilling is finished.

Other Synthetic Resins and/or Various Additives

Other Synthetic Resins

In addition to the preferred synthetic resins specifically cited above, the temporary plugging agent for well drilling containing synthetic resin of the present invention may also contain other synthetic resins within a range that does not hinder the object of the present invention. Thus, the period of plugging function of the temporary plugging agent for well drilling at 93 to 204° C. can be adjusted as desired within the range of not greater than 40 days, and in many cases not less than 2 days and not greater than 40 days. The other synthetic resins may be selected from other types of rubber materials (e.g., undegradable rubber materials such as nitrile rubber, polyisoprene, ethylene propylene rubber, butyl rubber, styrene-butadiene rubber, fluororubber, and silicone rubber, and the like) and other types of resins, without particular limitation. As preferred resins, degradable resins such as biodegradable, hydrolyzable, and thermally degradable resins may be used. Particularly preferred examples include known degradable resins such as PGA, PLA (in case it does not qualify as the synthetic resin contained in temporary plugging agents for well drilling containing synthetic resin, excluding stereocomplex polylactic acid), and glycolic acid-lactic acid copolymers, and mixtures thereof. In particular, by including a polyglycolic acid-based resin such as polyglycolic acid or glycolic acid-lactic acid copolymer, the period of plugging function at 93 to 204° C. can be easily adjusted as desired within the range of not greater than 40 days. The content of polyglycolic acid-based resin is preferably from 1 to 30% by mass, more preferably from 3 to 25% by mass, and even more preferably from 5 to 20% by mass, in the synthetic resin component.

Various Additives

The temporary plugging agent for well drilling containing synthetic resin of the present invention may further contain various blended agents typically added in temporary plugging agents for well drilling within a range that does not hinder the object of the present invention. Examples include various additives such as reinforcing materials, stabilizers, degradation accelerators or degradation inhibitors, and the like. These various additives can be used alone, or two or more types thereof can be used in combination.

Reinforcing Material

Examples of the reinforcing material include organic or inorganic fibrous reinforcing materials, granular or powdered reinforcing materials, and the like, which may be used alone or in combinations of two or more types. Examples of fibrous reinforcing materials include inorganic fibrous substances such as glass fibers, carbon fibers, asbestos fibers, silica fibers, alumina fibers, zirconia fibers, boron nitride fibers, silicon nitride fibers, boron fibers, and potassium titanate fibers; metal fibrous substances such as stainless steel, aluminum, titanium, steel, and brass; and organic fibrous substances with a high melting point such as aramid fibers, kenaf fibers, polyamides, fluorine resins, polyester resins, and acrylic resins; and the like. Examples of granular or powdered reinforcing materials include mica, silica, talc, alumina, kaolin, calcium sulfate, calcium carbonate, titanium oxide, ferrite, clay, glass powder, zinc oxide, nickel carbonate, iron oxide, quartz powder, magnesium carbonate, barium sulfate, and the like. The size (diameter and length, particle size, and the like) of the reinforcing material may be selected as appropriate. The reinforcing material may be treated with a sizing agent or surface treatment agent as necessary.

Degradation Accelerator

Examples of the degradation accelerator are acids and acid precursors. Acid precursors are preferred from the perspective of not affecting the chemical structure of the synthetic resin contained in the temporary plugging agent for well drilling containing synthetic resin of the present invention. Specific examples include lactones such as glycolide and lactide, acid anhydrides (e.g., 3,3′,4,4′-benzophenone tetracarboxylic dianhydride (BTDA) and the like), alkyl esters, sulfonic acid esters, phosphoric acid esters, and the like. Additionally, aliphatic polyesters such as PGA and PLA may also be used as degradation accelerators in cases where they do not qualify as the synthetic resin contained in the temporary plugging agent for well drilling containing synthetic resin.

The content of these other synthetic resins and/or various additives is selected as appropriate according to the borehole environment in which the temporary plugging agent for well drilling is used.

5. Temporary Plugging Function

(1) Having a Plugging Function for a Period of not Greater than 40 Days at 93 to 204° C.

The temporary plugging agent for well drilling of the present invention is a temporary plugging agent for well drilling containing synthetic resin that has a plugging function for a period of not greater than 40 days, and in many cases not less than 2 days and not greater than 40 days, at a temperature range between 93 and 204° C. That is, the temporary plugging agent for well drilling of the present invention is a temporary plugging agent for well drilling containing synthetic resin that has a plugging function for a period of not greater than 40 days, and in many cases not less than 2 days and not greater than 40 days, at a temperature range between 93 and 204° C., and loses the plugging function within that period. The temporary plugging agent for well drilling of the present invention has a temporary plugging function suitable for use in a high-temperature environment, due to having a plugging function for a period of not greater than 40 days, and in many cases not less than 2 days and not greater than 40 days, at a temperature range between 93 and 204° C., and then losing the plugging function within that period. Preferably, the above temporary plugging agent for well drilling may be obtained by including a synthetic resin having a compressive strength after a period of not greater than 40 days has elapsed at a temperature range between 93° C. and 204° C. of not less than 20% lower than the compressive strength before the period began. The period required for a plugging function in well drilling varies depending on the processes performed, but from the perspective of process safety and the like, there are few instances where a plugging function becomes unnecessary in a period of less than 30 minutes to 1 hour, and in many cases less than 2 days. On the other hand, from the perspective of shortening processes and the like, there are very few instances where a plugging function is required for more than 40 days. The temporary plugging agent for well drilling of the present invention is a temporary plugging agent that can be selected so as to have a plugging function for a desired period of not greater than 40 days, and in many cases not less than 2 days and not greater than 40 days, at a temperature range 93 and 204° C. Specifically, it can easily achieve a temporary plugging period that satisfies the required temporary plugging period depending on the application such as, for example, 3, 5, 7, 14, 21, or 35 days.

(2) Confirmation of Plugging Function

A plugging function is confirmed using a commercially available HP-HT filter press tester. Using a disk made of SUS having a thickness of 5 mm in which a slit 3 mm wide and 20 mm long has been provided, the slit is filled with the temporary plugging agent for well drilling, and with water as a pressure medium, the pressure is increased to 1,000 psi (7 MPa) at a temperature of 121° C. While maintaining that temperature and pressure, the time until water leaks from the slit (the temporary plugging agent for well drilling leaks out from the reverse side of the disk) is measured, and it is confirmed whether it is not greater than 40 days. Specifically, when the temporary plugging agent for well drilling has a plugging function in the above test device for a period of not greater than 40 days under pressure of 1,000 psi (7 MPa) at 121° C., it can be evaluated as having a temporary plugging function suitable for use in a high-temperature environment, namely a plugging function for a period of not greater than 40 days at 93 to 204° C.

It is deduced that there are primarily two factors involved in the temporary plugging agent for well drilling losing its plugging function in the plugging function test method described above. These are, specifically, the fact that the mass of the material that forms the temporary plugging agent for well drilling (as will be described later, having various shapes such as pellets, powders, and fibers, and various sizes) decreases not less than 20% from the initial mass, and the fact that the strength of the material decreases as it no longer withstands pressure. In general, the strength of the material that forms a temporary plugging agent for well drilling depends on the molecular weight of the contained synthetic resin, and needless to say, mass loss occurs due to the molecular weight decreasing. That is, there is a rough correlation between the plugging function of a temporary plugging agent for well drilling and the mass loss of the synthetic resin contained in the temporary plugging agent. Thus, the synthetic resin contained in the temporary plugging agent of the present invention preferably has an appropriate mass loss rate.

Furthermore, a method may also be employed as necessary to determine the temporary plugging function of the temporary plugging agent for well drilling suitable for use in, for example, a relatively low-pressure well environment or a relatively low-pressure well treatment. Specifically, one method that may be employed is, in the method for confirming the plugging function described above, to confirm the temporary plugging function of the temporary plugging agent for well drilling with the pressure being raised to 500 psi (3.5 MPa) instead of 1,000 psi (7 MPa) at 121° C. using water as the pressure medium. By this confirmation method in which the pressure is raised to 500 psi (3.5 MPa), it is possible to more correctly select a temporary plugging agent for well drilling suitable for use in a high-temperature environment in a relatively low-pressure well environment or in a relatively low-pressure well treatment, from among the temporary plugging agents for well drilling of the present invention which have a plugging function for a period of not greater than 40 days at 93 to 204° C., utilizing the fact that they have a plugging function in the above test device of not greater than 40 days at pressure 500 psi (3.5 MPa) and temperature 121° C. It should be noted that the temporary plugging agent for well drilling has a plugging function in the test device described above for a period of not greater than 40 days at a pressure of 1,000 psi (7 MPa) at 121° C.

Depending on the contemplated usage mode and the like, yet another method that may be employed for confirming the temporary plugging function of a temporary plugging agent for well drilling is a method in which, instead of the above method performed at 121° C. (implemented by raising the pressure to 1,000 psi or to 500 psi, for example), the test may be implemented at one temperature or at a plurality of temperatures in a range from 93 to 204° C., and furthermore, by raising the pressure to, for example, 3,000, 5,000, 10,000, or 15,000 psi.

(3) Preparation of Temporary Plugging Agent

The temporary plugging agent for well drilling containing synthetic resin of the present invention, which has a plugging function for a period of not greater than 40 days at 93 to 204° C., and in many cases not less than 2 days and not greater than 40 days, is, needless to say, a solid. Preferably, it may be prepared using one or a plurality of types of materials having various shapes and various sizes, which are formed from the synthetic resin having a compressive strength after a period of not greater than 40 days has elapsed at 93 to 204° C. of not less than 20% lower than the compressive strength before the period began, and/or synthetic resin having the above mass loss rate in 80° C. deionized water. Examples of the shape of the material that forms the temporary plugging agent include pellets, powders or granules, fibers (short fibers, whiskers, nonwoven fabrics, textiles, and the like), and film fragments (small fragments obtained by cutting or crushing film), and may be anything porous having small pores as long as it has a plugging function. Materials of various shapes and sizes may be obtained by known methods. Furthermore, materials of different shapes and/or sizes obtained from the same synthetic resin may be used in a mixture, and materials of different shapes and/or sizes obtained from different synthetic resins may be used in a mixture. The temporary plugging agent for well drilling containing synthetic resin of the present invention is typically a mixture of materials having various shapes and sizes, and may be prepared so as to have a plugging function for a desired period of not greater than 40 days at 93 to 204° C., and in many cases within a range of not less than 2 days and not greater than 40 days, depending on the combination of type, physical properties (molecular weight and the like), and composition of the synthetic resin and the shape and size of the material.

For example, when the temporary plugging agent for well drilling uses a mixture of materials of different shapes and sizes, a sufficient plugging function can be achieved by blocking relatively large-diameter gaps in a borehole with pellet-form or fiber-form materials, where these blocked sites are subjected to a pressure, while blocking relatively small-diameter gaps between the pellet-form materials in the borehole with a powdered or fiber-form material (fibers of relatively small fiber diameter and/or length, or the like). The optimal ranges of the physical properties and composition of the synthetic resin contained in the temporary plugging agent for well drilling and the shape and/or size of the materials as well as the combination thereof are selected according to a scale of a borehole, conditions of subterranean formation in which the borehole is constructed, the type of synthetic resin used, and the like. Furthermore, the synthetic resin contained in the temporary plugging agent for well drilling is preferably an elastomer, i.e., a rubber material, because it often can exhibit a plugging function by deforming under pressure during well drilling.

The temporary plugging agent for well drilling of the present invention (which is a temporary plugging agent for well drilling containing a synthetic resin having a plugging function for a period of not greater than 40 days at 93 to 204° C.) may be a temporary plugging agent for well drilling formed from two or more types of plugging agents for well drilling. In this case, the synthetic resin contained in at least one type of plugging agent for well drilling formed from two or more types of plugging agents for well drilling is preferably one that has a ratio of mass loss rate in 80° C. deionized water relative to the mass loss rate of PGA of not less than 0.001 and less than 1, and also has a compressive strength after a period of not greater than 40 days has elapsed at 93 to 204° C. of not less than 20% lower than the compressive strength before the period began. Furthermore, the two or more types of plugging agents for well drilling are all preferably plugging agents for well drilling containing synthetic resin having a plugging function for a period of not greater than 40 days at 93 to 204° C. Depending on the application and usage environment, it may also be a temporary plugging agent for well drilling containing synthetic resin formed from a plugging agent for well drilling containing synthetic resin having a plugging function for a period of not greater than 40 days at 93 to 204° C. and a plugging agent for well drilling containing synthetic resin having a plugging function for a period greater than 40 days at 93 to 204° C.

For a temporary plugging agent for well drilling formed from two or more types of plugging agents for well drilling, the two or more types of plugging agents for well drilling may also be temporary plugging agents for well drilling containing different synthetic resins. Different synthetic resins may mean different types of synthetic resin, or may mean the same synthetic resin having different molecular weight, crosslinking structure or degree of crosslinking, copolymer components, or the like.

For a temporary plugging agent for well drilling formed from two or more types of plugging agents for well drilling, the two or more types of plugging agents for well drilling may also be temporary plugging agents for well drilling that differ in at least one of shape and size. For example, they may be combinations of plugging agents for well drilling having different shapes, such as pellets, powders, or fibers, or combinations of plugging agents for well drilling having the same shape but different sizes such as fibers having different fineness or pellets with different sizes, or, furthermore, combinations of plugging agents for well drilling that differ in both shape and size.

For example, a temporary plugging agent for well drilling formed from two or more types of plugging agents for well drilling obtained by combining pellets containing synthetic resin with a high PGA-relative mass loss rate ratio and powder containing synthetic resin having a low PGA-relative mass loss rate ratio, can maintain a plugging function as a temporary plugging agent for well drilling for a certain period, depending primarily on the plugging function of the powder containing synthetic resin having a low PGA-relative mass loss rate ratio, even after mass loss or compressive strength decrease of the pellets (containing synthetic resin having a high PGA-relative mass loss rate ratio) begins, and then later lose the plugging function. As a result, the period for which the above temporary plugging agent for well drilling formed from pellets and powder can maintain a plugging function is in between the period for which the plug for well drilling formed from pellets can maintain a plugging function and the period for which the plug for well drilling formed from powder can maintain a plugging function. Thus, in the above temporary plugging agent for well drilling formed from pellets and powder, the period for which it can maintain a plugging function can be adjusted and controlled by varying the mixing proportion of the pellets and the powder. Furthermore, the period for which it can maintain a plugging function can also be adjusted and controlled by varying the compositions of one or both of the pellets and the powder.

Similarly, for example, in a temporary plugging agent for well drilling formed from two or more types of fiber of different fineness, or in a temporary plugging agent for well drilling formed from two of more types of powder of different particle size, or the like, the period for which it can maintain a plugging function can be adjusted and controlled by varying the compositions and the mixing proportions thereof, and the like.

Additionally, as described above in regard to unsaturated polyester, a temporary plugging agent for well drilling that dissolves and disappears due to contact with the hydrocarbon resource produced from the well may also be used as the temporary plugging agent for well drilling of the present invention, and further, a temporary plugging agent for well drilling that degrades and disappears due to contact with the above hydrocarbon resource may also be used.

Thereby, a temporary plugging agent for well drilling used in one or a plurality of processes among a diverting agent process, a cementing process, a perforation process, a fracturing process, and a completion process may be prepared, or a temporary plugging agent for well drilling that is a lost circulation material or a diverting agent may be prepared.

(4) Specific Example of Temporary Plugging Agent

Plugging Function of Thermoplastic Polyurethane

As the thermoplastic polyurethane, pellet-form molded articles of a lactone-based polyester-type polyurethane having a durometer type D hardness of 74° (a crosslinked-type elastomer) were obtained, and by further submitting them to a rubber miller, powder-form molded articles were obtained. The pellet-form molded articles and the powder-form molded articles were mixed, and when the plugging function test described above was performed, it was confirmed that the mixture maintains a slit plugging function up to day 11 and then loses the plugging function. For the above thermoplastic polyurethane, one with a higher degree of crosslinking is obtained by increasing the amount of crosslinking agent used or by performing electron beam crosslinking, and by performing the same plugging function test, it can be confirmed to maintain a slit plugging function up to day 16 and then lose the plugging function.

(5) Inference and Determination of Presence or Absence of Temporary Plugging Function

As a method for inferring and determining whether or not a synthetic resin can achieve a temporary plugging function in a high-temperature environment, the mass loss of various synthetic resins in water of a temperature encountered in a high-temperature environment was measured. Specifically, the time until the mass loss rate was not less than 20% was determined, and it was as follows. At a temperature of 93° C., for PGA it was 10 hours to 1.5 days; for poly-L-lactic acid is was 3 to 8 days; and for thermosetting polyurethane (polyester-type polyurethane) it was 20 hours to 3 days. At a temperature of 121° C., for thermoplastic polyurethane (polyester-type polyurethane, crosslinked type) it was 3 to 44 days; for thermoplastic polyurethane (polyester-type polyurethane, uncrosslinked type) it was 3 to 18 days; for aromatic polyester (polybutylene terephthalate) it was 4 to 40 days; and for stereocomplex polylactic acid it was 3 to 11 days. At a temperature of 177° C., for thermoplastic polyurethane (polyester-type polyurethane, crosslinked type) it was 6 hours to 6 days; for aliphatic polyamide it was 2 to 6 days, and for polycarbonate it was 3 to 13 days. Furthermore, for unsaturated polyester, the mass loss rate after approximately 2 days at 149° C. was not less than 20%, but after 3 days at 100° C., it was confirmed that the surface had cracked and had become brittle. From these results, it is inferred that in a temporary plugging agent for well drilling containing the above synthetic resins, the plugging function is lost after the confirmed number of days under the respective temperature conditions. Additionally, a temporary plugging agent for well drilling confirmed to have a plugging function for a period of, for example, from 5 to 30 days at 121° C. may also be used so as to lose its plugging function in a shorter time by using it at a higher temperature such as 177° C. Furthermore, it is surmised that the duration of this period of mass loss varied within a certain range depending on, in case of polyurethane for example, differences in degree of crosslinking, hardness, and structure, and conditions of the composition, such as the presence or absence of additives such as hydrolysis inhibitors or plasticizers. Additionally, for other synthetic resins, it is surmised that the duration of the period of mass loss varied within a certain range depending on molecular weight, structure, crystallinity, and the presence or absence of additives. Specifically, it was inferred that, by selecting a type, physical property and composition of synthetic resin, the plugging function can be controlled for a period in the range of not greater than 40 days, and in many cases not less than 2 days and not greater than 40 days, in a well environment at 93 to 204° C., as described above, by adjusting the degree of crosslinking and the hardness, or by the presence or absence of additives and the compounded amounts thereof, and that these synthetic resins can be selected according to different periods for which temporary plugging is required, such as 3, 5, 7, 14, 21, or 35 days, depending on the application.

Temporary Plugging Function in High High-Temperature Environment

The temporary plugging agent for well drilling containing synthetic resin of the present invention has a plugging function for a period of not greater than 40 days in a high-temperature well environment at 93 to 204° C. Above all, temporary plugging agents for well drilling used in even higher-temperature environments (sometimes called “high high-temperature environments” hereinafter), such as 149 to 191° C., are also demanded. A synthetic resin suitable for being contained in a temporary plugging agent for well drilling used in a high high-temperature environment may be evaluated and selected by the following method, for example. Specifically, synthetic resins that maintain their shape after being immersed for 3 hours in 149° C. deionized water (or having a mass loss rate of not greater than 10%) and that lose their shape or lose mass after being immersed for 3 days in 191° C. deionized water (for example, having a mass loss rate of not less than 50%) are often considered to have a temporary plugging function in a high high-temperature environment. Table 5 shows the mass loss rate (units: %) and the appearance related to shape and the like after immersion for 3 hours in 149° C. or 191° C. water for various synthetic resins, together with an evaluation (provisional evaluation) of suitability for the high high-temperature region.

TABLE 5

| | | Immersed 3 hr in | | Immersed 3 hr in | | |
|---|---|---|---|---|---|---|
| Synthetic | Melting | 149° C. water | | 191° C. water | | Suitability for high |
| resin | point | Mass loss | Appearance | Mass loss | Appearance | high-temperature |
| or the like | (° C.) | (%) | or the like | (%) | or the like | region |
| Nylon 6 | 218 | 3 | Shape | 100 | Dissolved | Unsuitable |
| | | | retained | | immediately | |
| Nylon 11 | 187 | 0.5 | Shape | 100 | Disappeared | Suitable |
| | | | retained | | | |
| Nylon 12 | 178 | 0.5 | Shape | — | Disappeared | Suitable |
| | | | retained | | | |
| Nylon 66 | 261 | 0.1 | Shape | 100 | Disappeared | Suitable |
| | | | retained | | | |
| MXD nylon | 236 | −2 | Shape | 100 | Disappeared | Suitable |
| | | | retained | | | |
| PBT | 222 | −0.1 | Shape | 0.3 | Blocking, | Unsuitable |
| | | | retained | | brittle | |
| PEN | 252 | −1 | Melted, | | Blocking | Unsuitable |
| (copolymer) | | | blocking | | | |
| APEXA | 197 | 44 | Brittle | | | Unsuitable |
| (trademark) | | | | | | |
| PET | 249 | −0.1 | Shape | 33 | Brittle, | Suitable |
| | | | retained | | crumbled | |
| PET + BTDA | 240 | 5 | Shape | 41 | Brittle, | Suitable |
| | | | retained | | crumbled | |
| PET + PGA + | 240 | 51 | Brittle | 67 | Brittle, | Unsuitable |
| BTDA | | | | | crumbled | |
| PBAT | 110 | — | Melted | | | Unsuitable |
| PBS | 115 | — | Melted | | | Unsuitable |
| Aramid | | — | Survived but | 5 | Survived | Unsuitable |
| | | | scattered | | | |
| PEEK | | 0.1 | Shape | 0.1 | Survived | Unsuitable |
| | | | retained | | | |

From Table 5 it can be deduced that nylon 11, nylon 12, nylon 66, MXD nylon, PET (polyethylene terephthalate), and the like are synthetic resins suitable to be contained in a temporary plugging agent for well drilling used in a high high-temperature environment. It should be noted that synthetic resins that dissolve immediately in 191° C. water, like nylon 6, are not suitable for use as temporary plugging agents for well drilling. Additionally, PBT and PEN (polyethylene naphthalate) are not suitable for use as temporary plugging agents for well drilling in a high high-temperature environment because blocking occurs in 190° C. water. Alumina and PEEK (polyether ether ketone) do not exhibit mass loss behavior at 149° C. or 191° C., and therefore are not suitable for use as a temporary plugging agent for well drilling. Furthermore, it is deduced that PBAT and PBS (polybutylene succinate) are not suitable for use as temporary plugging agents for well drilling in a high high-temperature environment because they can dissolve in a high high-temperature environment.

II. Well-Treatment Fluid

The present invention provides a well-treatment fluid containing the above-described temporary plugging agent for well drilling containing synthetic resin that has a plugging function for a period of not greater than 40 days, and in many cases not less than 2 days and not greater than 40 days, at a temperature of 93 to 204° C. The well-treatment fluid is not particularly limited, but examples include at least one type selected from the group consisting of a drilling fluid, a cementing fluid, a fracturing fluid, and a completion fluid.

For the well-treatment fluid containing the temporary plugging agent for well drilling containing synthetic resin of the present invention, a material is selected according to the environment in the borehole in which the well-treatment fluid is used, and particularly the temperature and the pressure of the high-temperature environment, by selecting the type, physical properties, and composition (including additives and the like) as well as the shape and size of the synthetic resin contained in the temporary plugging agent for well drilling. One type or a combination of a plurality of types of the selected materials are used in the relevant process. Thus, in the respective processes in which the temporary plugging agents for well drilling containing synthetic resin are used, a material or a combination of materials that differ from the temporary plugging agent for well drilling that is used may be employed. The concentration of the temporary plugging agent for well drilling containing synthetic resin of the present invention in the well-treatment fluid is not particularly limited, but is typically from 1 to 20% by mass, and in many cases from 5 to 15% by mass.

In addition to the temporary plugging agent for well drilling containing synthetic resin of the present invention, the above well-treatment fluid of the present invention may contain various additives typically added to well-treatment fluids, in a range that does not hinder the object of the present invention. Examples include gravel, which is a fluidity control agent, inorganic materials such as calcium carbonate, disintegration inhibitors such as KCl, specific gravity adjusting agents such as alkali metal halides or alkali earth metal halides, organic colloid agents such as guar gum, inorganic colloid agents (clays, and the like), dispersing deflocculants, surfactants, other lost circulation materials, diverting agents, defoaming agents, corrosion inhibitors, and the like. These may be included in a concentration selected as appropriate according to the environment in the borehole in which the relevant well-treatment fluid is used.

III. Method for Well Drilling

The present invention provides a method for well drilling including performing temporary plugging using the temporary plugging agent for well drilling containing synthetic resin of the present invention having a plugging function for a period of not greater than 40 days, and in many cases not less than 2 days and not greater than 40 days, at 93 to 204° C. described above, and in particular, a temporary plugging agent for well drilling h containing synthetic resin having a plugging function for a period of not greater than 40 days at 93 to 204° C., wherein the contained synthetic resin preferably has a ratio of mass loss rate in 80° C. deionized water relative to the mass loss rate of polyglycolic acid of not less than 0.001 and less than 1, and also has a compressive strength after a period of not greater than 40 days has elapsed at a temperature range between 93 and 204° C. of not less than 20% lower than the compressive strength before the period began. In the method for well drilling, the process in which the temporary plugging agent for well drilling containing synthetic resin of the present invention is used is not particularly limited, but according to the present invention, it may be a method for well drilling using the temporary plugging agent for well drilling containing synthetic resin of the present invention in one or a plurality of processes among a drilling process, a cementing process, a perforation process, a fracturing process, and a completion process. Additionally, it may be a method for well drilling in which the fluid for temporary plugging containing the temporary plugging agent for well drilling of the present invention is pumped into the borehole before the well-treatment fluid is pumped into the borehole.

A material is selected according to the environment of the process in which the containing synthetic resin temporary plugging agent for well drilling containing synthetic resin of the present invention is used, particularly the temperature and pressure of a high-temperature environment, by selecting the type, physical properties, and composition, as well as the shape and size of the synthetic resin contained in the temporary plugging agent for well drilling. One type or a combination of a plurality of types of the selected materials is used in the relevant process. Thus, as described above, for each process in which the temporary plugging agent for well drilling containing synthetic resin is used, a different material or a different combination of materials may be employed for the temporary plugging agent for well drilling that is used.

Additionally, as the method for well drilling of the present invention, the various methods for well drilling described above that use the temporary plugging agent for well drilling containing synthetic resin of the present invention, i.e., a temporary plugging agent for well drilling having a plugging function for a period of not greater than 40 days at 93 to 204° C., together with a plugging agent for well drilling having a plugging function for a period greater than 40 days at 93 to 204° C., may be employed. In this case, due to the fact that the temporary plugging agent for well drilling containing synthetic resin having a plugging function for a period of not greater than 40 days at 93 to 204° C. loses its plugging function, the plugging agent for well drilling having a plugging function for a period greater than 40 days at 93 to 204° C. can no longer maintain its initial state in which it is suitable for demonstrating a plugging function, and as a result, the plugging function is lost in a period of not greater than 40 days at 93 to 204° C. Furthermore, as the method for well drilling of the present invention, the various methods for well drilling described above, in which, after temporary plugging is performed using the temporary plugging agent for well drilling of the present invention, the plug is released by contacting a material that can degrade the temporary plugging agent for well drilling, may be employed. Examples of the material that can degrade the temporary plugging agent for well drilling include fluids containing a substance that can cause reduction in the strength of the temporary plugging agent for well drilling or mass loss of the temporary plugging agent for well drilling, such as an acid (optionally an acid-producing substance or the like) or an alkali.

### INDUSTRIAL APPLICABILITY

The present invention has high industrial applicability because it can provide a temporary plugging agent for well drilling that can reduce expenses and shorten processes of well drilling due to having a temporary plugging function suitable for use in high-temperature environments, under the circumstances that excavation conditions have become more harsh and diverse such as increased depth. This can be achieved by a temporary plugging agent for well drilling comprising a synthetic resin having a plugging function for a period of not greater than 40 days, and in many cases not less than 2 days and not greater than 40 days, at a temperature range between 93° and 204° C., and in particular, a temporary plugging agent for well drilling containing synthetic resin having a plugging function for a period of not greater than 40 days at 93 to 204° C., and preferably by the above temporary plugging agent for well drilling wherein the contained synthetic resin has a ratio of mass loss rate in 80° C. deionized water relative to the mass loss rate of polyglycolic acid of not less than 0.001 and less than 1, and/or has a compressive strength after a period of not greater than 40 days has elapsed at 93° C. to 204° C. of not less than 20% lower than the compressive strength before the period began.

Additionally, the present invention has high industrial applicability because it can provide well-treatment fluid or a method for well treatment that can reduce expenses and shorten processes of well drilling due to having a temporary plugging function suitable for use in high-temperature environments, under the circumstances that excavation conditions have become more harsh and diverse such as increased depth. This can be achieved by a method for well treatment including performing temporary plugging using a well-treatment fluid containing the above temporary plugging agent for well drilling or using the above temporary plugging agent for well drilling.

1. A temporary plugging agent for well drilling containing synthetic resin having a plugging function for a period of not greater than 40 days at a temperature range between 93° C. (200° F.) and 204° C. (400° F.).

2. The temporary plugging agent for well drilling according to claim 1, wherein the plug has a plugging function for a period of not less than 2 days and not greater than 40 days.

3. The temporary plugging agent for well drilling according to claim 1, wherein a compressive strength of a synthetic resin after a period of not greater than 40 days at a temperature range between 93° C. (200° F.) and 204° C. (400° F.) is not less than 20% lower than the compressive strength before the period began.

4. The temporary plugging agent for well drilling according to claim 1, wherein the mass loss rate in 80° C. deionized water of the synthetic resin is a ratio of not less than 0.001 and less than 1 relative to a mass loss rate of polyglycolic acid.

5. The temporary plugging agent for well drilling according to claim 3, wherein the synthetic resin comprises at least one type selected from the group consisting of polyurethane, polylactic acid, aromatic polyester, aliphatic polyamide, and polycarbonate.

6. The temporary plugging agent for well drilling according to claim 3, wherein the synthetic resin comprises at least one type selected from the group consisting of thermoplastic polyurethane, stereocomplex polylactic acid, polylactic acid containing a hydrolysis inhibitor, and aromatic polyester.

7. The temporary plugging agent for well drilling according to claim 3, wherein the synthetic resin comprises at least one of a polybutylene adipate terephthalate random copolymer and an unsaturated polyester.

8. The temporary plugging agent for well drilling according to claim 3, wherein the synthetic resin comprises a polyglycolic acid-based resin.

9. The temporary plugging agent for well drilling according to claim 1, wherein the plug is formed from not less than two types of plugging agents for well drilling.

10. The temporary plugging agent for well drilling according to claim 9, wherein all of the not less than two types of plugging agents for well drilling are synthetic resin-containing temporary plugging agents for well drilling having a plugging function for a period of not greater than 40 days at a temperature range between 93° C. (200° F.) and 204° C. (400° F.).

11. The temporary plugging agent for well drilling according to claim 9, wherein the not less than two types of plugging agents for well drilling comprise different synthetic resins.

12. The temporary plugging agent for well drilling according to claim 9, wherein the not less than two types of plugging agents for well drilling differ in at least one of shape and size.

13. The temporary plugging agent for well drilling according to claim 1, wherein the plugging agent disappears by dissolving or degrading by contacting a hydrocarbon resource produced from a well.

14. The temporary plugging agent for well drilling according to claim 1, wherein the plugging agent is used in one or a plurality of processes among a drilling process, a cementing process, a perforation process, a fracturing process, and a completion process.

15. The temporary plugging agent for well drilling according to claim 1, wherein the plugging agent is a lost circulation material or a diverting agent.

16. A well-treatment fluid comprising the temporary plugging agent for well drilling described in claim 1.

17. The well-treatment fluid according to claim 16, wherein the fluid is at least one type selected from the group consisting of a drilling fluid, a cementing fluid, a fracturing fluid, and a completion fluid.

18. A method for well drilling including performing temporary plugging using the temporary plugging agent for well drilling described in claim 1.

19. The method for well drilling according to claim 18, wherein the temporary plugging agent for well drilling described in claim 1 is used in one or a plurality of processes among a drilling process, a perforation process, a fracturing process, and a completion process.

20. The method for well drilling according to claim 18, wherein a plugging agent for well drilling having a plugging function for a period of greater than 40 days at a temperature range between 93° C. (200° F.) and 204° C. (400° F.) is used together with the temporary plugging agent for well drilling described in claim 1.

21. The method for well drilling according to claim 18, wherein, after temporary plugging is performed using the temporary plugging agent for well drilling described in claim 1, the plugging agent is released by contacting a material that can degrade the temporary plugging agent for well drilling.
